(19) United States
(12) Patent Application Publication
(10) Pub. No.: US 2024/0061420 A1
(43) Pub. Date: Feb. 22, 2024

(54) CONTRACT TESTING FOR AUTONOMOUS VEHICLES

(71) Applicant: GM Cruise Holdings LLC, San Francisco, CA (US)

(72) Inventors: Aravindha Ganesh Ramakrishnan, Santa Clara, CA (US); Kyle Liang, Cerritos, CA (US)

(21) Appl. No.: 17/890,771

(22) Filed: Aug. 18, 2022

(51) Int. Cl. G05D 1/00

(52) U.S. Cl. CPC G05D 1/0022; G05D 1/0088

(57) ABSTRACT

Systems and techniques are provided for testing software nodes. An example method can determine respective contracts between nodes of an operating system of a computer, the nodes including provider nodes and consumer nodes; generate, based on the respective contracts, one or more provider node proxies and one or more consumer node proxies; generate one or more first messages between the one or more provider nodes or the one or more provider node proxies and the one or more consumer node proxies or the one or more consumer nodes; generate one or more second messages between the one or more consumer nodes or the one or more consumer node proxies and the one or more provider node proxies or the one or more provider nodes; and determine, based on the one or more first messages and/or the one or more second messages, a state of one or more contracts of the respective contracts.

### TECHNICAL FIELD

The present disclosure generally relates to autonomous vehicles. For example, aspects of the present disclosure relate to techniques and systems for testing contracts between software nodes of autonomous vehicles.

### BACKGROUND

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at specific locations on the autonomous vehicles.

### BRIEF DESCRIPTION OF THE DRAWINGS

Illustrative examples and aspects of the present application are described in detail below with reference to the following figures:

FIG. 1 is a diagram illustrating an example system environment that can be used to facilitate autonomous vehicle (AV) navigation and routing operations, in accordance with some examples of the present disclosure;

FIG. 2 is a diagram illustrating an example configuration for discovering contracts between nodes of a software of an autonomous vehicle, in accordance with some examples of the present disclosure;

FIG. 3 is a diagram illustrating another example configuration for discovering contracts between nodes of a software of an autonomous vehicle, in accordance with some examples of the present disclosure;

FIG. 4A is a diagram illustrating an example for generating proxies to test node contracts, in accordance with some examples of the present disclosure;

FIG. 4B is a diagram illustrating an example test of a contract between nodes of an operating system of an autonomous vehicle, in accordance with some examples of the present disclosure;

FIG. 5 is a flowchart illustrating an example process for testing contracts between nodes of an operating system of an autonomous vehicle, in accordance with some examples of the present disclosure;

FIG. 6 is a diagram illustrating an example system architecture for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of aspects and examples of the application. However, it will be apparent that various aspects and examples may be practiced without these specific details. The figures and description are not intended to be restrictive.

The ensuing description provides aspects and examples of the disclosure, and is not intended to limit the scope, applicability, or configuration of the disclosure. Rather, the ensuing description of the aspects and examples of the disclosure will provide those skilled in the art with an enabling description for implementing an example implementation of the disclosure. It should be understood that various changes may be made in the function and arrangement of elements without departing from the scope of the application as set forth in the appended claims.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

As previously explained, autonomous vehicles (AVs) can include various sensors, such as a camera sensor, a light detection and ranging (LIDAR) sensor, a radio detection and ranging (RADAR) sensor, amongst others, which the AVs can use to collect data and measurements that the AVs can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system.

AV software is generally constructed using frameworks such as, for example, a robot operating system (ROS), which include software nodes that communicate with other software nodes via messages and/or publish/subscribe models (e.g., publishing and/or subscribing to certain topics). In some examples, a node can include and/or represent a process running on the ROS of an AV. A node can include a name, which the node can register with an ROS master. In some cases, multiple nodes with different names can exist under different namespaces, or a node can be defined as anonymous, in which case it can generate an additional identifier to add to its given name.

Nodes can take actions based on information received from other nodes, send information to other nodes, or send and receive requests for actions to and from other nodes. Typically, the nodes in the AV software (e.g., in the ROS) may communicate with each other based on contracts. The contracts can define what nodes communicate with what nodes, which nodes are provider nodes (e.g., sender) and which nodes are consumer nodes (e.g., recipient) in specific node communications, what data is communicated between specific nodes, the format of messages communicated between nodes, node dependencies (e.g., what information a node may expect/require from another node), and/or other aspects of node behaviors and/or communications.

In many cases, the AV software (e.g., the ROS) may include a large number of nodes, which can make it very difficult for developers to test and troubleshoot the nodes and associated contracts. Moreover, nodes are often developed and/or maintained by different people and/or teams. As a result, it can be difficult for developers to track the changes to nodes made by other developers and/or teams. In addition, when a person or team makes a change to a configuration/behavior of a node, such change can impact other nodes and/or associated contracts that may be managed by other developers or teams.

For example, when a developer makes a change to a configuration or behavior of a node, such change may affect the functionality of other nodes managed by other developers and/or teams. If the change breaks or negatively impacts the functionality of the other nodes, the developers and/or teams that manage such nodes may not become aware of the change that caused such issues or the timing when such issues were created, which can make it difficult for those developers and/or teams to troubleshoot the problem.

In some cases, problems in the code of a node or a contract between nodes may be discovered using end-to-end tests, where all nodes and contracts of the AV software are tested. However, the end-to-end tests are typically expensive to run in terms of time and compute cost, and may not be feasible for all scenarios. Moreover, when a problem associated with a node(s) and/or contract arises, it can be difficult to debug the root cause of the problem. Indeed, it can be difficult to even keep track of or discover all the nodes in the AV software or the various contracts between nodes.

Systems, apparatuses, processes (also referred to as methods), and computer-readable media (collectively referred to as “systems and techniques”) are described herein for discovering and testing contracts between nodes in AV software. In some aspects, the systems and techniques described herein can efficiently and programmatically discover nodes and/or contracts between nodes in the AV software, and identify specific issues with contracts between nodes without performing an end-to-end test of the AV software. The systems and techniques described herein can significantly reduce the cost of test and troubleshooting nodes in terms of time and compute cost, and can make it easier to validate the AV software, an AV software update, and/or an AV software release.

Contracts between nodes can surface (e.g., define or identify, describe, correlate, etc.) any dependencies across nodes. A dependency between nodes can represent or include what data is needed or expected by one node from another node. For example, a dependency of a consumer node can represent or include any data that the consumer node needs from a particular provider node in order for the consumer node to generate a particular output, provide a particular functionality, and/or process certain information. In some cases, a contract between nodes can also define a message schema for messages between the nodes and/or how a consumer node of the nodes should process data (e.g., dependencies) from a provider node of the nodes. The message schema can define a format of the messages between the nodes, how the nodes should communicate, a structure of data communicated between the nodes, and/or any other aspects of communications between the nodes.

The contract tests implemented according to the systems and techniques described herein can detect any breakages in contracts between nodes and/or node dependencies. In some cases, when there are any breakages in contracts and/or node dependencies, the provider node's code may need to be updated to fix the issue or otherwise reverted to its prior behavior so the consumer nodes are not negatively impacted. If the change in behavior of the provider node is intentional or required, the consumer node may need to have its dependency code changed, along with an associated contract. The systems and techniques described herein can efficiently and accurately discover such changes in node behavior and/or contracts and any issues caused by such changes.

When there are issues in the AV software, given the complexity of AV software, it can be very difficult to go back and manually create contracts between different nodes. In order to scale, the systems and techniques described herein can discover contracts in the AV software programmatically. In some examples, the systems and techniques described herein can discover contracts by implementing listeners (e.g., software agents/services) that listen to the traffic between nodes and automatically construct contracts between nodes based on the traffic captured between nodes and associated information. In other examples, the systems and techniques described herein can discover contracts by programmatically scraping node definitions and message schemas, which together provide the information that can enable the systems and techniques described herein to understand what contracts should be implemented between nodes and the configuration of such contracts.

In some cases, the systems and techniques described herein can implement listeners and/or scrape node definitions and message schemas in a ground truth version of the AV software. The ground truth version of the AV software can include, for example, a version of the AV software known to be stable and/or functioning properly. If there are any changes to the AV software or a new release of the AV software, the systems and techniques described herein can discover contracts in the AV software after such changes or in the new release, and compare them with the contracts discovered in the ground truth version of the AV software to determine any discrepancies and/or any potential problems.

In some examples, the systems and techniques described herein can build proxies or mirror copies of one or more provider and consumer nodes to perform the contract testing as described herein. For example, once a contract between nodes is built, the systems and techniques described herein can use such contract to build proxies or mirror copies of the provider and consumer nodes associated with the contract. In some cases, the provider node can use the consumer node proxy or mirror copy during unit and integration tests to ensure that dependencies associated with the consumer node are not broken or negatively affected, and the consumer node can use the provider proxy or mirror copy to ensure that dependencies associated with the provider node are implemented correctly. For example, the node proxies or mirror copies can be used to verify the communications (e.g., inputs, outputs, replies, message formats, data in communications, etc.) between provider and consumer nodes. Using node proxies or mirror copies, the systems and techniques described herein can test specific nodes and/or associated contracts without having to perform an end-to-end test of the entire AV software. Thus, the systems and techniques described herein provide testing flexibility and efficiency, allow focused/targeted testing and avoid unnecessary testing.

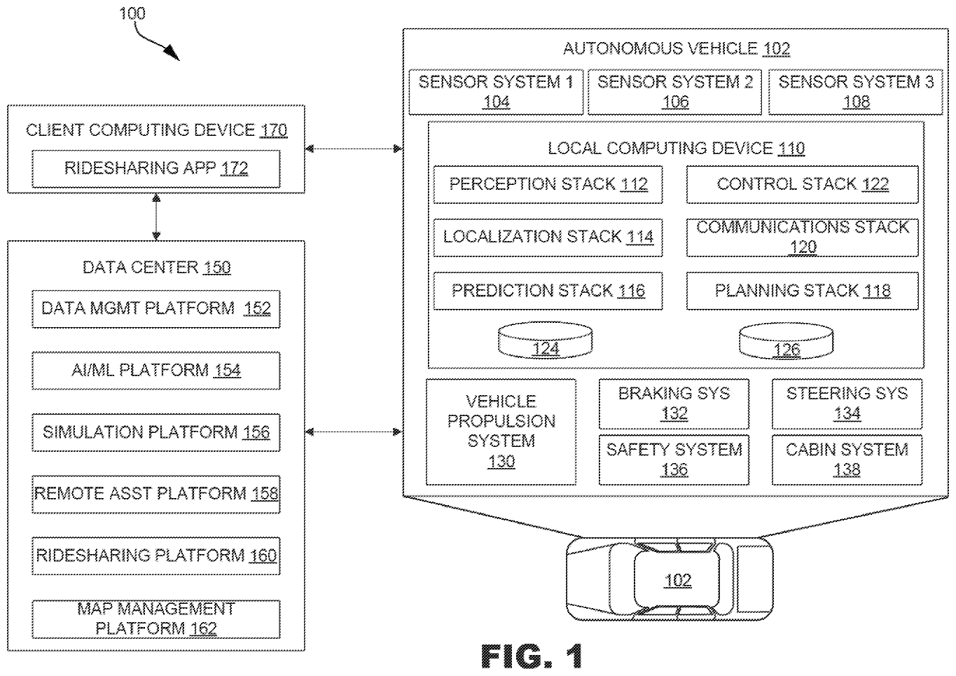

Examples of the systems and techniques described herein for processing data are illustrated in FIG. 1 through FIG. 6 and described below.

FIG. 1 is a diagram illustrating an example autonomous vehicle (AV) environment 100, according to some examples of the present disclosure. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and/or the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and/or other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162 and/or a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridesharing application 172. In some cases, the client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the client application 172 to enable passengers to view the AV 102 in transit to a pick-up or drop-off location, and so on.

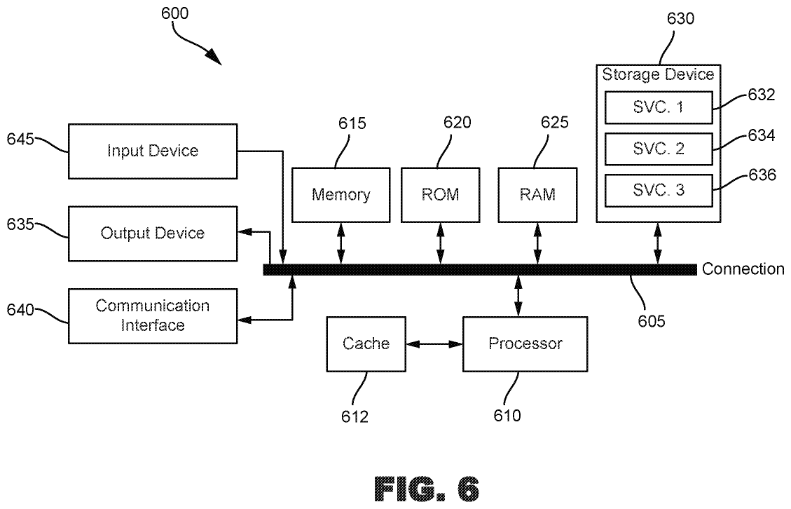

While the AV 102, the local computing device 110, and the autonomous vehicle environment 100 are shown to include certain systems and components, one of ordinary skill will appreciate that the AV 102, the local computing device 110, and/or the autonomous vehicle environment 100 can include more or fewer systems and/or components than those shown in FIG. 1. For example, the AV 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 6.

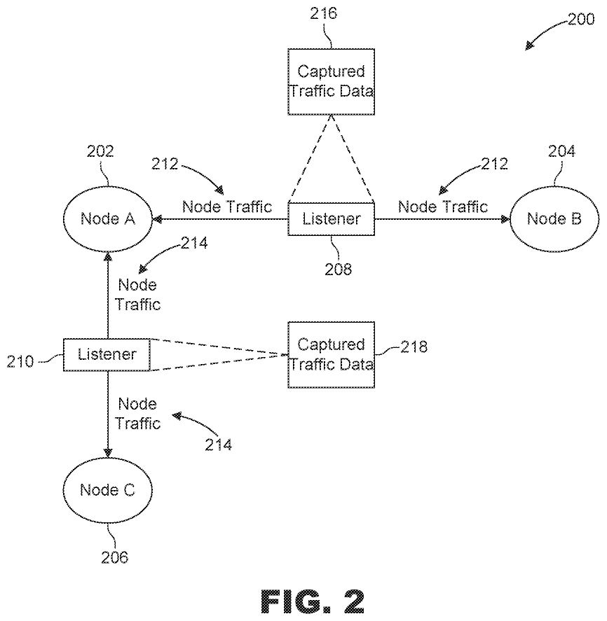

FIG. 2 is a diagram illustrating an example configuration 200 for discovering contracts between nodes of an AV software. In this example, node 202 and node 204 have a contract defining communications with each other. For example, the contract can define one or more node dependencies (e.g., what data/inputs are needed/expected by a consumer node from a provider node, what data should be sent from a provider node to a consumer node, etc.) of a consumer node (e.g., node 202 or node 204), a message schema for communications between node 202 and node 204, which node is a provider node in the contract and which node is a consumer node in the contract, an ordering of data to be communicated between node 202 and node 204, how a consumer node in the contract should use data dependencies from a provider node in the contract, and/or any information about the data/communications between node 202 and node 204.

To illustrate, a contract between node 202 and node 204 can define that node 202 is a provider node and node 204 is a consumer node with respect to certain (or all) communications between node 202 and node 204, what data node 204 needs to receive from node 202, how node 204 is supposed to use the data received from node 202, what data (if any) node 204 needs to send to node 202, a format of the data communicated between node 202 and node 204, and/or any other information about the data/communications between node 202 and node 204. In some cases, the contract can define communications between more than two nodes. For example, if node 202 is a provider node under the contract, the contract may define that node 204 and one or more additional nodes are consumer nodes for data from node 202. In this example, the contract can define what data should be communicated between the nodes (e.g., dependencies), how consumer nodes should use data received from the provider node (e.g., node 202), one or more message schemas, etc.

A listener 208 can capture (e.g., intercept, record, review, store copies, etc.) node traffic 212 between node 202 and node 204 to obtain captured traffic data 216. The captured traffic data 216 can be used to discover a contract between node 202 and node 204. In some examples, the captured traffic data 216 can include a copy of the node traffic 212, information extracted or identified from the node traffic 212, etc. The listener 208 can include, for example, a software agent or service, a software script, a software program, a software service, and/or a piece of code. In some cases, the listener 208 can reside within a path between node 202 and node 204. For example, the listener 208 can reside on a software and/or hardware host between node 202 and node 204. Moreover, the listener 208 can be configured to intercept and forward traffic between node 202 and node 204.

In other cases, the listener 208 can reside within node 202 and/or node 204. For example, the listener 208 can include code residing at node 202 and configured to capture traffic sent and received by node 202, which can include traffic from node 202 to node 204 and/or traffic from node 204 to node 202. As another example, the listener 208 can include code residing at node 204 and configured to capture traffic sent and received by node 204, which can include traffic from node 202 to node 204 and/or traffic from node 204 to node 202. As yet another example, the listener 208 can include a portion of code residing at node 202 and configured to capture traffic sent and/or received by node 202, and a portion of code residing at node 204 and configured to capture traffic sent and/or received by node 204.

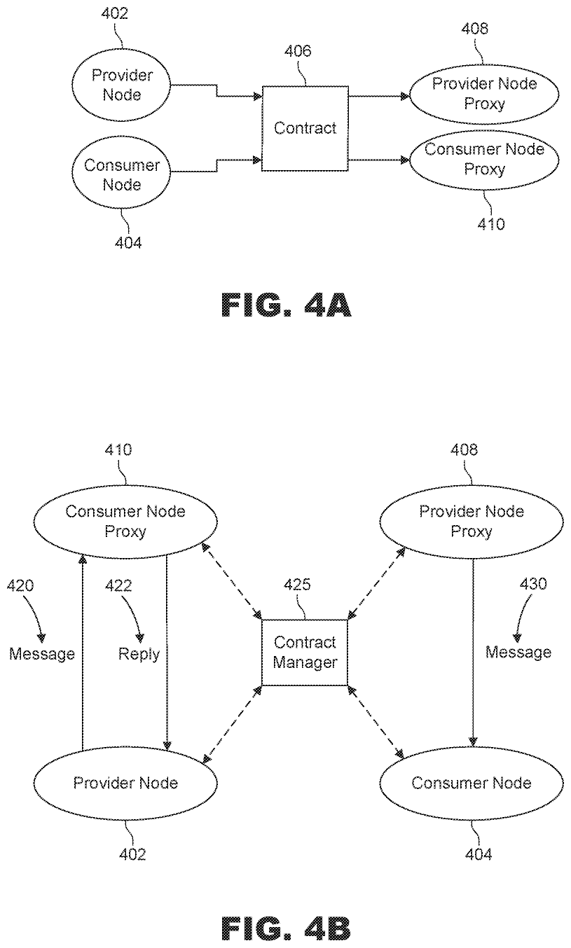

As previously mentioned, the listener 208 (or a different entity such as a contract manager (e.g., contract manager 425 shown in FIG. 4B)) can use the captured traffic data 216 to discover a contract between node 202 and node 204. For example, the listener 208 can use the captured traffic data 216 to determine what information is communicated between node 202 and node 204, which node is the sender of certain information and which node is the receiver of certain information (e.g., which node sends what and which node receives what), the format of data in the captured traffic data 216, an order of data between the node 202 and the node 204, and/or any other information regarding communications between the node 202 and the node 204. From the information in the captured traffic data 216, the listener 208 (or another entity such as a contract manager) can determine sufficient information to discover a contract between node 202 and node 204, such as which node is a provider node and which node is a consumer node in certain communications between the node 202 and the node 204, node dependencies (e.g., what data inputs are needed/expected by the consumer node, what data the provider node needs to send to the consumer node, how the consumer node should use data from the provider node, and/or any other dependencies), a message schema for communications between the node 202 and the node 204, a node behavior, etc.

In FIG. 2, node 202 and node 206 also have a contract defining communications with each other. For example, a contract between node 202 and node 206 can define that node 206 is a provider node and node 202 is a consumer node with regards to certain (or all) communications between node 202 and node 206, what data node 206 needs to send to node 202, how node 202 is supposed to use the data received from node 206, what data (if any) node 202 needs to send to node 206, a format of the data communicated between node 202 and node 206, and/or any other information about the data/communications between node 202 and node 204.

A listener 210 can capture node traffic 214 between node 202 and node 206 to obtain captured traffic data 218. The captured traffic data 218 can be used to discover a contract between node 202 and node 206. In some examples, the listener 210 can be a different listener than the listener 208. In other examples, the listener 208 and the listener 210 can represent a same listener or different portions of a same listener.

The captured traffic data 218 can include, for example, a copy of the node traffic 214, information extracted or identified from the node traffic 214, etc. The listener 210 (or a different entity such as a contract manager) can use the captured traffic data 218 to discover a contract between node 202 and node 206. For example, the listener 210 can use the captured traffic data 218 to determine what information is communicated between node 202 and node 206, which node is the sender of certain information and which node is the receiver of certain information (e.g., which node sends what and which node receives what), the format of data in the captured traffic data 218, an order of data between the node 202 and the node 206, and/or any other information regarding communications between the node 202 and the node 206. From this information in the captured traffic data 218, the listener 210 (or another entity) can determine sufficient information to discover a contract between node 202 and node 206, such as which node is a provider node and which node is a consumer node in certain communications between the node 202 and the node 206, node dependencies (e.g., what data inputs are needed/expected by the consumer node, what data the provider node needs to send to the consumer node, how the consumer node should use data from the provider node, and/or any other dependencies), a message schema for communications between the node 202 and the node 206, a node behavior, etc.

In some examples, a listener (or another entity such as a contract manager) can compare one or more contracts determined from an AV software (e.g., from an AV's ROS) being developed, modified, and/or updated with one or more corresponding contracts in a version of the AV software identified as stable. The comparison can indicate whether the one or more contracts determined in the AV software being developed, modified, and/or updated are consistent with the one or more corresponding contracts in the version of the AV software identified as stable.

If the comparison indicates that the one or more contracts determined in the AV software being developed, modified, and/or updated are consistent with the one or more corresponding contracts in the version of the AV software identified as stable, the listener (or another entity) can determine that the one or more contracts determined in the AV software being developed, modified, and/or updated are accurate/valid. On the other hand, if the comparison indicates that the one or more contracts determined in the AV software being developed, modified, and/or updated conflict or are inconsistent with the one or more corresponding contracts in the version of the AV software identified as stable, the listener (or another entity) can determine that the one or more contracts determined in the AV software being developed, modified, and/or updated may be potentially inaccurate, invalid, or have changed in the AV software being developed, modified, and/or updated.

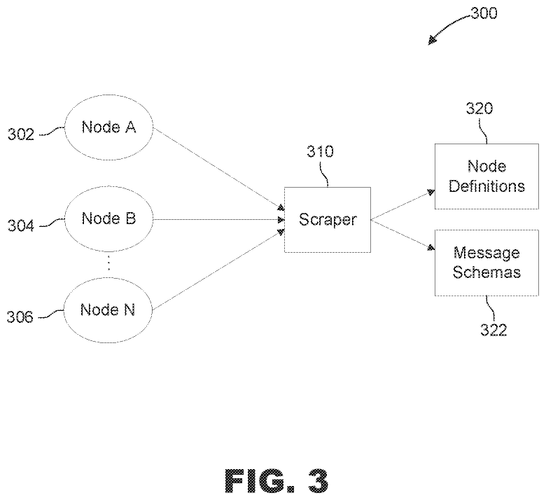

FIG. 3 is a diagram illustrating another example configuration 300 for discovering contracts between nodes of an AV software. In this example, node 302, node 304, and node 306 have contracts defining communications with each other. For example, node 302 and node 304 can have a contract where node 302 is the provider of certain data to node 304 and node 304 is the consumer of data from node 302, and node 304 and node 306 can have a contract where node 304 is the provider of certain data to node 306 and node 306 is the consumer of data from node 304.

To determine the contract between node 302 and node 304 and the contract between node 304 and node 306, a scraper 310 can scrape (e.g., crawl, search, extract, obtain, etc.) nodes 302, 304, and 306. The scraper 310 can include, for example, a software agent or service, a piece of software code, a crawler, a script, and/or a software program. When scraping the nodes 302, 304, and 306, the scraper 310 can extract and/or identify node definitions 320 of the nodes 302, 304, and 306 and message schemas 322. The message schemas 322 can define a format of messages between the nodes 302, 304, and 306. For example, the message schemas 322 can define a format of messages between node 302 and node 304, and a format of messages between node 304 and node 306. In some examples, the format of messages defined in the message schemas 322 can indicate a structure of data, one or more fields in data messages, an encapsulation of data messages, a protocol(s) used for the messages, acceptable types of data in messages, an order of certain data in messages, how messages should be addressed, and/or any other message information.

The node definitions 320 can provide information about the nodes 302, 304, and 306. For example, in some cases, the node definitions 320 can identify a contract between a node and another node. In other cases, the node definitions 320 can identify information that can be used to determine a contract between a node and another node. To illustrate, in such cases, the node definitions 320 can define an identity of a node (e.g., provider, consumer, etc.), node dependencies (e.g., what data the node is supposed to exchange (e.g., send and/or receive) with another node), how the node is supposed to use received data, an output of the node, a behavior of the node, and/or other information that can be used to determine a contract between the node and another node.

The scraper 310 can scrape a subset of nodes in the AV software or all of the nodes in the AV software. For example, the scraper 310 can scrape nodes 302, 304, and 306 if it only needs to determine contracts associated with nodes 302, 304, and 306. If the scraper 310 needs to discover all contracts in the AV software, the scraper 310 can scrape all nodes in the AV software.

In some examples, the scraper 310 can scrape all nodes of a version of the AV software previously determined to be a stable version to discover all contracts in a stable version of the AV software. For example, the scraper 310 can scrape all nodes in a version of the AV software that has undergone a certain amount of use and/or testing to verify a certain stability of the AV software and/or a version of the AV software that has been determined to be stable. In some cases, the scraper 310 can scrape one or more nodes in a version of the AV software being developed, modified, and/or updated to determine one or more contracts between the one or more nodes in the AV software.

In some examples, the scraper 310 (or another entity such as a contract manager) can compare the one or more contracts determined from the AV software being developed, modified, and/or updated with one or more corresponding contracts in the version of the AV software identified as stable. The comparison can indicate whether the one or more contracts determined in the AV software being developed, modified, and/or updated are consistent with the one or more corresponding contracts in the version of the AV software identified as stable.

If the comparison indicates that the one or more contracts determined in the AV software being developed, modified, and/or updated are consistent with the one or more corresponding contracts in the version of the AV software identified as stable, the scraper 310 (or another entity) can determine that the one or more contracts determined in the AV software being developed, modified, and/or updated are accurate/valid. On the other hand, if the comparison indicates that the one or more contracts determined in the AV software being developed, modified, and/or updated conflict or are inconsistent with the one or more corresponding contracts in the version of the AV software identified as stable, the scraper 310 (or another entity) can determine that the one or more contracts determined in the AV software being developed, modified, and/or updated may be potentially inaccurate, invalid, or have changed in the AV software being developed, modified, and/or updated.

FIG. 4A is a diagram illustrating an example for generating proxies to test node contracts. As shown, provider node 402 and consumer node 404 have a contract 406 between each other. The contract 406 can be used to create a provider proxy 408 and a consumer proxy 410, which can be used to test the contract 406 as further described herein.

For example, the contract 406 can be used to create node definitions for the provider proxy 408 and the consumer proxy 410. In some cases, the contract 406 can also be used to configure the provider proxy 408 and the consumer proxy 410 to format communications with each other according to a message schema defined in the contract 406.

The provider proxy 408 can be configured to behave like the provider node 402 (e.g., to receive and process the same inputs, to generate the same outputs, to provide the same functionality, etc.), and the consumer proxy 410 can be configured to behave like the consumer node 404 (e.g., to receive and process the same inputs, to generate the same outputs, to provide the same functionality, etc.). In some cases, the provider proxy 408 can include a mirror copy of the provider node 402 associated with the contract 406. Moreover, the consumer proxy 410 can include a mirror copy of the consumer node 404 associated with the contract 406.

While FIG. 4A illustrates the provider proxy 408 and the consumer proxy 410 generated from the contract 406, in other examples, provider proxy 408 and the consumer proxy 410 can be generated by cloning or copying the provider node 402 and the consumer node 404.

FIG. 4B is a diagram illustrating an example test of a contract between nodes of an AV operating system. As previously explained, the provider node 402 and the consumer node 404 can include a contract 406 defining node dependencies (e.g., dependencies of data from the provider node 402 to the consumer node 404) and a message schema defining communications between the provider node 402 and the consumer node 404.

In the example shown in FIG. 4B, the provider node 402 can use the consumer proxy 410 to test any dependencies defined in the contract 406, such as any dependencies of the consumer node 404 for data from the provider node 402, and the consumer node 404 can use the provider proxy 408 to test whether the consumer node 404 is properly using any dependencies for data from the provider node 402. For example, if a developer modifies a code of the provider node 402, the consumer node 404, and/or any other nodes of the AV operating system, the provider node 402 can use the consumer proxy 410 to test any dependencies defined in the contract 406 and/or the consumer node 404 can use the provider proxy 408 to test whether the consumer node 404 is properly using any dependencies for data from the provider node 402.

In some examples, the provider node 402 can send a message 420 to the consumer proxy 410 to verify that the dependencies between the provider node 402 and the consumer node 404 are not broken (e.g., missing, have errors, etc.). The message 420 can include, for example, input data that, according to the contract 406, the consumer node 404 (and thus the consumer proxy 410) should receive from the provider node 402 in order to generate a particular output expected from the consumer node 404 and/or to perform a particular functionality. The consumer proxy 410 can receive the message 420, review the contract 406 to determine how to use/process the input data in the message 420 and/or whether the information in the message 420 is correct, complete, and/or causes an error in the processing of the input data and/or an output generated based on the input data.

In some cases, the consumer proxy 410 or a contract manager 425 can determine whether the dependencies are broken based on the dependencies defined in the contract 406 and/or the information in the message 420. For example, in some cases, the contract manager 425 can analyze the data in the message 420 to determine whether the data contains all of the dependencies expected by the consumer node 404 (and thus the consumer proxy 410) from the provider node 402. As another example, in some cases, the contract manager 425 can additionally or alternatively analyze an output generated by the consumer proxy 410 from the data in the message 420 to determine whether the output has any errors, alerts, inaccuracies, and/or missing information, and/or analyze how the consumer proxy 410 processes the data in the message 420. The contract manager 425 can determine whether any of the dependencies of the consumer node 404 from the provider node 402 are broken based on the output generated by the consumer proxy 410 and/or how the consumer proxy 410 processes the data in the message 420. The contract manager 425 can include, for example and without limitation, a piece of code, a service agent, an AV node, and/or any software program.

In other cases, the consumer proxy 410 can be programmed to send a reply 422 to the provider node 402 with information indicating whether any dependencies of the consumer node 404 are broken, as shown in FIG. 4B. In some examples, the information in the reply 422 can include a log generated by the consumer proxy 410 based on processing of data in the message 420, details describing how the data in the message 420 was used by the consumer proxy 410, an error message, a validation message, an output generated by the consumer proxy 410 based on the data from the message 420, an indication of any missing or incorrect information in the data from the message 420, processing parameters, a response to the data from the message 420, and/or any other information indicative of a validity of the dependencies defined in the contract 406. In an illustrative example, the consumer proxy 410 can be programmed to analyze the message 420 from the provider node 402, and formulate the reply 422 to the provider node 402. In some cases, the consumer proxy 410 can send the reply 422 to the provider node 402 for analysis. In other cases, the consumer proxy 410 can additionally or alternatively send the reply 422 to the contract manager 425.

In some examples, the contract manager 425 (and/or the provider node 402) can analyze the reply 422 to determine whether any dependencies for data needed by the consumer node 404 from the provider node 402 are broken (e.g., are missing in the data from the message 420, are incorrect, include an error, are malformed, etc.). For example, the contract manager 425 (and/or the provider node 402) can determine, based on the reply 422, whether the reply 422 includes a correct output that the consumer node 404 (and thus the consumer proxy 410) is expected to generate based on data from the provider node 402, whether the reply 422 includes any processing errors from the consumer proxy 410, whether the reply 422 indicates that the message 420 is missing data (or has incorrect data) expected by the consumer proxy 410 to generate the reply 422 (and/or an output), whether details and/or a log in the reply 422 indicates any problems or missing data encountered by the consumer proxy 410 when processing the data in the message 420, and/or whether the reply 422 includes information otherwise indicating any problems with the dependencies of the consumer node 404 for data from the provider node 402.

As shown in FIG. 4B, in some examples, the consumer node 404 can use the provider proxy 408 to test whether the dependencies defined in the contract 406 (e.g., the dependencies of the consumer node 404 for data from the provider node 402) are being used correctly by the consumer node 404. For example, the consumer node 404 can obtain a message 430 from the provider proxy 408 with input data (e.g., dependencies) that the consumer node 404 can process to determine whether the input data (e.g., the dependencies) from the provider proxy 408 (and thus the provider node 402) are used correctly by the consumer node 404. In some cases, the consumer node 404 and/or the contract manager 425 can check processing information (e.g., a processing log, an output, an error, a response, etc.) generated by the consumer node 404 based on the input data from the provider proxy 408 to determine whether the input data was used correctly by the consumer node 404.

In some cases, if the consumer node 404 generates an error when processing the input data from the provider proxy 408 and/or if an output generated by the consumer node 404 based on the input data has a problem (e.g., an inconsistency, missing information, an incorrect structure, an incorrect value, etc.), the error in processing the input data and/or the problem in the output can be used to determine that the dependencies of the consumer node 404 (e.g., from the provider node 402) are not being used correctly by the consumer node 404 (e.g., are processed as expected, are used to generate a correct/expected output, result in an expected/intended functionality when processed by the consumer node 404, etc.). Alternatively, if the consumer node 404 does not generate an error when processing the input data or if an output generated by the consumer node 404 based on the input data does not have a problem (e.g., an inconsistency, missing information, an incorrect structure, an incorrect value, etc.), the lack of an error when processing the input data or a problem in the output can be used to determine that the dependencies are being used correctly. For example, in some cases, the contract manager 425 can analyze an output generated by the consumer node 404 based on the message 430 and/or processing information generated by the consumer node 404 based on the message 430 to determine whether any dependencies of the consumer node 404 (e.g., from the provider node 402) are being used correctly by the consumer node 404.

In some cases, instead of the provider node 402 communicating with the consumer proxy 410 and/or the provider proxy 408 communicating with the consumer node 404 to test the contract 406, the provider proxy 408 and the consumer proxy 410 can communicate with each other to test the contract 406. For example, the provider proxy 408 can send a message to the consumer proxy 410 with input data such as dependencies defined in the contract 406. The consumer proxy 410 and/or the contract manager 425 can check the input data and/or an output generated by the consumer proxy 410 based on the input data to determine whether the input data from the provider proxy 408 includes all of the correct dependencies. In some cases, the consumer proxy 410 can process the input data, and the processing of the input data and/or the output(s) generated based on the input data can be used to determine if the input data (e.g., the dependencies) was used correctly by the consumer proxy 410.

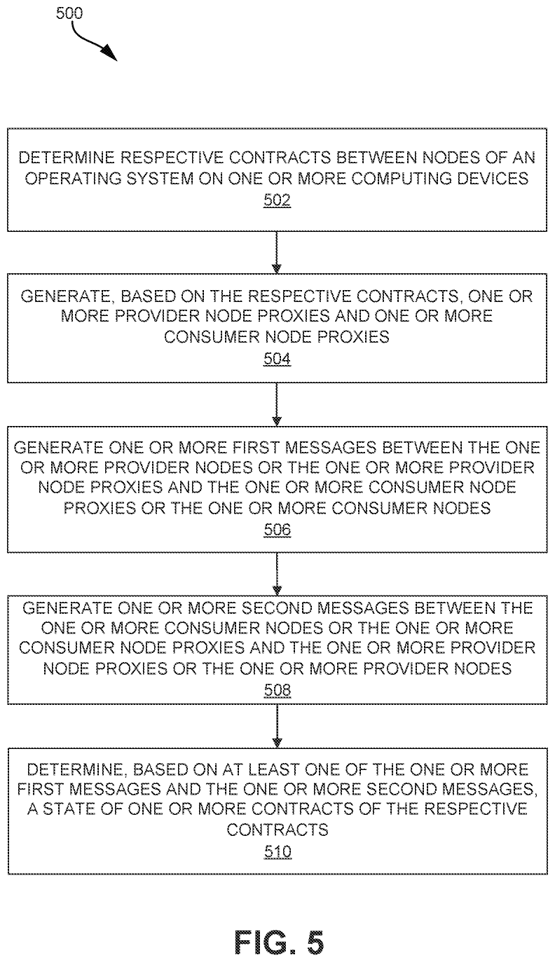

FIG. 5 is a flowchart illustrating an example process 500 for testing contracts between nodes of an AV operating system. At block 502, the process 500 can include determining respective contracts between nodes of an operating system on one or more computing devices. In some examples, the nodes can include one or more provider nodes and one or more consumer nodes. In some cases, the one or more computing devices can include a computer (e.g., local computing device 110) of an autonomous vehicle (e.g., AV 102).

In some aspects, determining the respective contracts between nodes of the operating system can include capturing messages between the nodes of the operating system, and identifying the respective contacts between the nodes based on the captured messages. In some examples, determining the respective contracts between nodes of the operating system further include determining, for each message of the captured messages, a sender of the message and a recipient of the message; determining, for each message of the captured messages, data included in the message; and determining the respective contracts based on the data in the message, the sender of the message, and the recipient of the message.

In some cases, determining the respective contracts between nodes of the operating system further can include determining, for each message of the captured messages, a provider node associated with the message, a consumer node associated with the message, and a message schema associated with the message based on the data in the message, the sender of the message, and the recipient of the message; and determining a respective contract between the provider node and the consumer node based on the data in the message and the determining of the provider node, the consumer node, and the message schema.

In some cases, determining the respective contracts between nodes of the operating system can include extracting, from the nodes, node definitions and message schemas defined for the nodes; and determining the respective contracts based on the node definitions and the message schemas.

At block 504, the process 500 can include generating, based on the respective contracts, one or more provider node proxies and one or more consumer node proxies. For example, in some cases, a contract manager (e.g., contract manager 425) can analyze each contract between nodes and use the contract to generate provider node proxies and consumer node proxies. To illustrate, a contract between two nodes can define communications (e.g., data dependencies, a message schema, a provider node role of the nodes, a consumer node role of the nodes, etc.) between the nodes. The contract manager can use the contract defining communications between two nodes to generate a provider node proxy for a provider node from the two nodes and a consumer node proxy for a consumer node from the two nodes. The provider node proxy can be configured to generate and send data to a consumer node in the contract (and/or the consumer node proxy), and the consumer node proxy can be configured to process data from the provider node proxy (and/or an associated provider node) and generate an output (e.g., a reply, a log, a result, etc.) based on the data. The data from the provider node proxy can be used to determine whether any dependencies between associated provider node and an associated consumer node are broken.

In some cases, the one or more provider node proxies can mirror or replicate one or more provider nodes in the AV operating system. Similarly, in some cases, the one or more consumer node proxies can mirror or replicate one or more consumer nodes in the AV operating system.

In some examples, generating one or more provider node proxies and one or more consumer node proxies can include generating the one or more provider node proxies and the one or more consumer node proxies based on at least a portion of the respective contracts. For example, in some cases, a contract manager (e.g., contract manager 425) can review a contract between two nodes and use the details in the contract to generate a provider node proxy mirroring a provider node associated with the contract and/or a consumer node proxy mirroring a consumer node associated with the contract. In some cases, the details in the contract can define a message schema for communications between the two nodes, identify which of the two nodes is the provider node and which is the consumer node, define any data dependencies between the provider node and the consumer node (e.g., what data the consumer node should receive from the provider node), and/or how the consumer node should use data from the provider node.

At block 506, the process 500 can include generating one or more first messages between the one or more provider nodes or the one or more provider node proxies, and the one or more consumer node proxies or the one or more consumer nodes. For example, the one or more provider nodes can generate one or more first messages to one or more consumer node proxies (and/or one or more consumer nodes) associated with one or more contracts between the one or more consumer nodes and the one or more provider nodes. The one or more first messages can include data for the one or more consumer nodes or the one or more consumer node proxies. In some examples, the one or more first messages can include data dependencies between the one or more consumer nodes and one or more provider nodes associated with the one or more contracts.

For example, each message from the one or more provider nodes or one or more provider node proxies can include any data dependencies defined in a contract between a provider node and a consumer node. The data dependencies can include data that the consumer node expects and/or needs from the provider node in order to formulate a particular output(s) and/or provide a particular functionality.

At block 508, the process 500 can include generating one or more second messages between the one or more consumer node proxies or the one or more consumer nodes, and the one or more provider node proxies or the one or more provider nodes associated with the one or more provider node proxies. For example, the one or more consumer node proxies can generate the one or more second messages from one or more messages sent by the one or more provider node proxies or the one or more provider nodes associated with the one or more provider node proxies. The one or more messages received from the one or more provider nodes (and/or the one or more provider node proxies) can include data dependencies between the one or more consumer nodes and the one or more provider nodes. In some examples, the one or more messages received from the one or more provider nodes (or the one or more provider node proxies) can include the one or more first messages described in block 506 of FIG. 5. In other examples, the one or more messages received form the one or more provider nodes (or the one or more provider node proxies) can include one or more messages that are separate from the one or more first messages described in block 506 of FIG. 5.

In some examples, the one or more second messages can include data generated by the one or more consumer node proxies or the one or more consumer nodes associated with the one or more consumer node proxies. For example, in some cases, the one or more second messages can include one or more outputs generated by the one or more consumer node proxies or the one or more consumer nodes based on the one or more first messages from the one or more provider nodes or the one or more provider node proxies. As another example, in some cases, the one or more second messages can additionally or alternatively include another message(s) generated by the one or more consumer node proxies or the one or more consumer nodes based on the one or more first messages from the one or more provider nodes or the one or more provider node proxies.

In some cases, the one or more second messages can include a log or details indicating how the one or more consumer node proxies or the one or more consumer nodes processed the one or more first messages from the one or more provider nodes or the one or more provider node proxies, any errors generated by the one or more consumer node proxies or the one or more consumer nodes when processing the one or more first messages, a response to the one or more first messages, a message indicating an estimated validity and/or completeness of the data in the one or more first messages, a message indicating whether the one or more first messages include all of the data dependencies between the one or more provider nodes and the one or more consumer nodes, and/or other information.

At block 510, the process 500 can include determining, based on the one or more first messages and/or the one or more second messages, a state of one or more contracts of the respective contracts. In some examples, determining the state of one or more contracts can include determining whether there is a first error in one or more data dependencies of a consumer node associated with the one or more contracts and/or whether there is a second error in how the consumer node is configured to use the one or more data dependencies.

In some cases, each contract of the respective contracts can define a message schema for messages between a set of nodes associated with the contract, a provider node from the set of nodes, a consumer node from the set of nodes, and/or one or more data dependencies associated with the consumer node.

In some aspects, the process 500 can include sending, from a provider node from the nodes to a consumer node proxy from the one or more consumer node proxies, a message from the one or more first messages, determining whether the message satisfies all dependencies of the consumer node for data from the provider node, and based on the determining whether the message satisfies all the dependencies of the consumer node for data from the provider node, determining the state of the contract between the provider node and the consumer node. In some examples, the message can include one or more data dependencies of a consumer node associated with the consumer node proxy. In some cases, the message can be configured based on a contract between the provider node and the consumer node.

In some aspects, the process 500 can include receiving, by a consumer node from a provider node proxy of the one or more provider node proxies, one or more provider messages including one or more data dependencies of the consumer node, generating, by the consumer node, an output based on the one or more data dependencies associated with the one or more provider messages and, based on the output, determining whether there are any errors in how the consumer node uses the one or more data dependencies. In some examples, the one or more provider messages are configured based on a contract between the consumer node and a provider node associated with the provider node proxy.

FIG. 6 illustrates an example processor-based system with which some aspects of the subject technology can be implemented. For example, processor-based system 600 can be any computing device making up local computing device 110, remote computing system 190, a passenger device executing the ridesharing application 170, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some examples, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (CPU or processor) 610 and connection 605 that couples various system components including system memory 615, such as read-only memory (ROM) 620 and random-access memory (RAM) 625 to processor 610. Computing system 600 can include a cache of high-speed memory 612 connected directly with, in close proximity to, and/or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 can include an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L#), resistive random-access memory (RRAM/ReRAM), phase change memory (PCM), spin transfer torque RAM (STT-RAM), another memory chip or cartridge, and/or a combination thereof.

Storage device 630 can include software services, servers, services, etc., that when the code that defines such software is executed by the processor 610, causes the system to perform a function. In some examples, a hardware service that performs a particular function can include the software component stored in a computer-readable medium in connection with the necessary hardware components, such as processor 610, connection 605, output device 635, etc., to carry out the function.

As understood by those of skill in the art, machine-learning techniques can vary depending on the desired implementation. For example, machine-learning schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: a memory; and one or more processors coupled to the memory, the one or more processors being configured to: determine respective contracts between nodes of an operating system on one or more computing devices, the nodes comprising one or more provider nodes and one or more consumer nodes; generate, based on the respective contracts, one or more provider node proxies and one or more consumer node proxies; generate one or more first messages between the one or more provider nodes or the one or more provider node proxies and the one or more consumer node proxies or the one or more consumer nodes; generate one or more second messages between the one or more consumer node proxies or the one or more consumer nodes and the one or more provider node proxies or the one or more provider nodes; and determine, based on the one or more first messages and/or the one or more second messages, a state of one or more contracts of the respective contracts.

Aspect 2. The system of Aspect 1, wherein determining the respective contracts between nodes of the operating system comprises: capturing messages between the nodes of the operating system; and identifying the respective contacts between the nodes based on the captured messages.

Aspect 3. The system of claim 2, wherein determining the respective contracts between nodes of the operating system further comprises: determining, for each message of the captured messages, a sender of the message and a recipient of the message; determining, for each message of the captured messages, data included in the message; and determining the respective contracts based on the data in the message, the sender of the message, and the recipient of the message.

Aspect 4. The system of claim 3, wherein determining the respective contracts between nodes of the operating system further comprises: based on the data in the message, the sender of the message, and the recipient of the message, determining, for each message of the captured messages, a provider node associated with the message, a consumer node associated with the message, and a message schema associated with the message; and determining a respective contract between the provider node and the consumer node based on the determining of the provider node, the consumer node, and the message schema.

Aspect 5. The system of any of Aspects 1 to 4, wherein determining the respective contracts between nodes of the operating system comprises: extracting, from the nodes, node definitions and message schemas defined for the nodes; and determining the respective contracts based on the node definitions and the message schemas.

Aspect 6. The system of any of Aspects 1 to 5, wherein each contract of the respective contracts defines at least one of a message schema for messages between a set of nodes associated with the contract, a provider node from the set of nodes, a consumer node from the set of nodes, and one or more data dependencies associated with the consumer node.

Aspect 7. The system of any of Aspects 1 to 6, wherein determining the state of one or more contracts comprises determining whether there is a first error in one or more data dependencies of a consumer node associated with the one or more contracts and/or whether there is a second error in how the consumer node is configured to use the one or more data dependencies.

Aspect 8. The system of any of Aspects 1 to 7, wherein generating one or more provider node proxies and one or more consumer node proxies comprises generating the one or more provider node proxies and the one or more consumer node proxies based on at least a portion of the respective contracts.

Aspect 9. The system of any of Aspects 1 to 8, wherein the one or more processors are configured to: send, from a provider node from the nodes or a provider node proxy associated with the provider node to a consumer node or a consumer node proxy associated with the consumer node, a message from the one or more first messages, the message comprising one or more data dependencies of the consumer node associated with the consumer node proxy, wherein the message is configured based on a contract between the provider node and the consumer node; determine whether the message satisfies all dependencies of the consumer node for data from the provider node; and based on the determining whether the message satisfies all the dependencies of the consumer node for data from the provider node, determine the state of the contract between the provider node and the consumer node.

Aspect 10. The system of any of Aspects 1 to 9, wherein the one or more processors are configured to: receive, by a consumer node or a consumer node proxy associated with the consumer node, from a provider node or a provider node proxy associated with the provider node, one or more messages comprising one or more data dependencies of the consumer node, wherein the one or more messages are configured based on a contract between the consumer node and a provider node associated with the provider node proxy; generate, by the consumer node or the consumer node proxy, an output based on the one or more data dependencies associated with the one or more messages; and based on the output, determine whether there are any errors in how the consumer node uses the one or more dependencies.

Aspect 11. A method comprising: determining respective contracts between nodes of an operating system on one or more computing devices, the nodes comprising one or more provider nodes and one or more consumer nodes; generating, based on the respective contracts, one or more provider node proxies and one or more consumer node proxies; generating one or more first messages between the one or more provider nodes or the one or more provider node proxies and the one or more consumer node proxies or the one or more consumer nodes; generating one or more second messages between the one or more consumer node proxies or the one or more consumer nodes and the one or more provider nodes or the one or more provider node proxies; and determining, based on the one or more first messages and/or the one or more second messages, a state of one or more contracts of the respective contracts.

Aspect 12. The method of Aspect 11, wherein determining the respective contracts between nodes of the operating system comprises: capturing messages between the nodes of the operating system; and identifying the respective contacts between the nodes based on the captured messages.

Aspect 13. The method of Aspect 12, wherein determining the respective contracts between nodes of the operating system further comprises: determining, for each message of the captured messages, a sender of the message and a recipient of the message; determining, for each message of the captured messages, data included in the message; and determining the respective contracts based on the data in the message, the sender of the message, and the recipient of the message.

Aspect 14. The method of Aspect 13, wherein determining the respective contracts between nodes of the operating system further comprises: based on the data in the message, the sender of the message, and the recipient of the message, determining, for each message of the captured messages, a provider node associated with the message, a consumer node associated with the message, and a message schema associated with the message; and determining a respective contract between the provider node and the consumer node based on the determining of the provider node, the consumer node, and the message schema.

Aspect 15. The method of any of Aspects 11 to 14, wherein determining the respective contracts between nodes of the operating system comprises: extracting, from the nodes, node definitions and message schemas defined for the nodes; and determining the respective contracts based on the node definitions and the message schemas.

Aspect 16. The method of any of Aspects 11 to 15, wherein each contract of the respective contracts defines at least one of a message schema for messages between a set of nodes associated with the contract, a provider node from the set of nodes, a consumer node from the set of nodes, and one or more data dependencies associated with the consumer node.

Aspect 17. The method of any of Aspects 11 to 16, wherein the one or more provider node proxies and the one or more consumer node proxies are generated based on at least a portion of the respective contracts.

Aspect 18. The method of any of Aspects 11 to 17, wherein determining the state of one or more contracts comprises determining whether there is a first error in one or more data dependencies of a consumer node associated with the one or more contracts and/or whether there is a second error in how the consumer node is configured to use the one or more data dependencies.

Aspect 19. The method of any of Aspects 11 to 18, further comprising: sending, from a provider node or a provider node proxy associated with the provider node, to a consumer node proxy or a consumer node associated with the consumer node proxy, a message from the one or more first messages, the message comprising one or more data dependencies of the consumer node, wherein the message is configured based on a contract between the provider node and the consumer node; determining whether the message satisfies all dependencies of the consumer node for data from the provider node; and based on the determining whether the message satisfies all the dependencies of the consumer node for data from the provider node, determining the state of the contract between the provider node and the consumer node.

Aspect 20. The method of any of Aspects 11 to 19, further comprising: receiving, by a consumer node or a consumer node proxy associated with the consumer node, from a provider node proxy or a provider node proxy, one or more messages comprising one or more data dependencies of the consumer node, wherein the one or more messages are configured based on a contract between the consumer node and the provider node; generating, by the consumer node or the consumer node proxy, an output based on the one or more data dependencies associated with the one or more messages; and based on the output, determining whether there are any errors in how the consumer node uses the one or more dependencies.

Aspect 21. The method of any of Aspects 11 to 20, wherein the one or more computing devices comprise a computer system of an autonomous vehicle.

Aspect 22. A non-transitory computer-readable medium having stored thereon instructions which, when executed by one or more processors, cause the one or more processors to perform a method according to any of Aspects 11 to 21.

Aspect 23. A system comprising means for performing a method according to any of Aspects 11 to 21.

Aspect 24. The system of Aspect 23, wherein the system comprises an autonomous vehicle.

Aspect 25. A computer-program product including instructions which, when executed by one or more processors, cause the one or more processors to perform a method according to any of Aspects 11 to 21.

What is claimed is:

1. A system comprising:
a memory; and
one or more processors coupled to the memory, the one or more processors being configured to:
determine respective contracts between nodes of an operating system on one or more computing devices, the nodes comprising one or more provider nodes and one or more consumer nodes;
generate, based on the respective contracts, one or more provider node proxies and one or more consumer node proxies;
generate one or more first messages between the one or more provider nodes or the one or more provider node proxies and the one or more consumer node proxies or the one or more consumer nodes;
generate one or more second messages between the one or more consumer nodes or the one or more consumer node proxies and the one or more provider node proxies or the one or more provider nodes; and
determine, based on at least one of the one or more first messages and the one or more second messages, a state of one or more contracts of the respective contracts.

2. The system of claim 1, wherein determining the respective contracts between nodes of the operating system comprises:
capturing messages between the nodes of the operating system; and
identifying the respective contacts between the nodes based on the captured messages.

3. The system of claim 2, wherein determining the respective contracts between nodes of the operating system further comprises:
determining, for each message of the captured messages, a sender of the message and a recipient of the message;
determining, for each message of the captured messages, data included in the message; and
determining the respective contracts based on the data in the message, the sender of the message, and the recipient of the message.

4. The system of claim 3, wherein determining the respective contracts between nodes of the operating system further comprises:
determining, for each message of the captured messages, a provider node associated with the message, a consumer node associated with the message, and a message schema associated with the message based on the data in the message, the sender of the message, and the recipient of the message; and
determining a respective contract between the provider node and the consumer node based on the data in the message and the determining of the provider node, the consumer node, and the message schema.

5. The system of claim 1, wherein determining the respective contracts between nodes of the operating system comprises:
extracting, from the nodes, node definitions and message schemas defined for the nodes; and
determining the respective contracts based on the node definitions and the message schemas.

6. The system of claim 1, wherein each contract of the respective contracts defines at least one of a message schema for messages between a set of nodes associated with the contract, a provider node from the set of nodes, a consumer node from the set of nodes, and one or more data dependencies associated with the consumer node.

7. The system of claim 1, wherein determining the state of one or more contracts comprises determining at least one of whether there is a first error in one or more data dependencies of a consumer node associated with the one or more contracts and whether there is a second error in how the consumer node is configured to use the one or more data dependencies.

8. The system of claim 1, wherein generating one or more provider node proxies and one or more consumer node proxies comprises generating the one or more provider node proxies and the one or more consumer node proxies based on at least a portion of the respective contracts.

9. The system of claim 1, wherein the one or more processors are configured to:
send, from a provider node from the nodes to a consumer node proxy from the one or more consumer node proxies, a message from the one or more first messages, the message comprising one or more data dependencies of a consumer node associated with the consumer node proxy, wherein the message is configured based on a contract between the provider node and the consumer node;
determine whether the message satisfies all dependencies of the consumer node for data from the provider node; and
based on the determining whether the message satisfies all the dependencies of the consumer node for data from the provider node, determine the state of the contract between the provider node and the consumer node.

10. The system of claim 1, wherein the one or more processors are configured to:
receive, by a consumer node from a provider node proxy of the one or more provider node proxies, one or more provider messages comprising one or more data dependencies of the consumer node, wherein the one or more provider messages are configured based on a contract between the consumer node and a provider node associated with the provider node proxy;
generate, by the consumer node, an output based on the one or more data dependencies associated with the one or more provider messages; and
based on the output, determine whether there are any errors in how the consumer node uses the one or more data dependencies.

11. A method comprising:
determining respective contracts between nodes of an operating system on one or more computing devices, the nodes comprising one or more provider nodes and one or more consumer nodes;
generating, based on the respective contracts, one or more provider node proxies and one or more consumer node proxies;
generating one or more first messages between the one or more provider nodes or the one or more provider node proxies and the one or more consumer node proxies or the one or more consumer nodes;
generating one or more second messages between the one or more consumer nodes or the one or more consumer node proxies and the one or more provider node proxies or the one or more provider nodes; and
determining, based on at least one of the one or more first messages and the one or more second messages, a state of one or more contracts of the respective contracts.

12. The method of claim 11, wherein determining the respective contracts between nodes of the operating system comprises:
capturing messages between the nodes of the operating system; and
identifying the respective contacts between the nodes based on the captured messages.

13. The method of claim 12, wherein determining the respective contracts between nodes of the operating system further comprises:
determining, for each message of the captured messages, a sender of the message and a recipient of the message;
determining, for each message of the captured messages, data included in the message; and
determining the respective contracts based on the data in the message, the sender of the message, and the recipient of the message.

14. The method of claim 13, wherein determining the respective contracts between nodes of the operating system further comprises:
determining, for each message of the captured messages, a provider node associated with the message, a consumer node associated with the message, and a message schema associated with the message, the provider node, the consumer node, and the message schema being determined based on the data in the message, the sender of the message, and the recipient of the message; and
determining a respective contract between the provider node and the consumer node based on the determining of the provider node, the consumer node, and the message schema.

15. The method of claim 11, wherein determining the respective contracts between nodes of the operating system comprises:
extracting, from the nodes, node definitions and message schemas defined for the nodes; and
determining the respective contracts based on the node definitions and the message schemas.

16. The method of claim 11, wherein each contract of the respective contracts defines at least one of a message schema for messages between a set of nodes associated with the contract, a provider node from the set of nodes, a consumer node from the set of nodes, and one or more data dependencies associated with the consumer node, and wherein the one or more provider node proxies and the one or more consumer node proxies are generated based on at least a portion of the respective contracts.

17. The method of claim 11, wherein determining the state of one or more contracts comprises determining at least one of whether there is a first error in one or more data dependencies of a consumer node associated with the one or more contracts and whether there is a second error in how the consumer node is configured to use the one or more data dependencies.

18. The method of claim 11, further comprising:
sending, from a provider node from the nodes to a consumer node proxy from the one or more consumer node proxies, a message from the one or more first messages, the message comprising one or more data dependencies of a consumer node associated with the consumer node proxy, wherein the message is configured based on a contract between the provider node and the consumer node;
determining whether the message satisfies all dependencies of the consumer node for data from the provider node; and
based on the determining whether the message satisfies all the dependencies of the consumer node for data from the provider node, determining the state of the contract between the provider node and the consumer node.

19. The method of claim 11, further comprising:
receiving, by a consumer node from a provider node proxy of the one or more provider node proxies, one or more provider messages comprising one or more data dependencies of the consumer node, wherein the one or more provider messages are configured based on a contract between the consumer node and a provider node associated with the provider node proxy;
generating, by the consumer node, an output based on the one or more data dependencies associated with the one or more provider messages; and
based on the output, determining whether there are any errors in how the consumer node uses the one or more dependencies.

20. A non-transitory computer-readable medium having stored thereon instructions which, when executed by one or more processors, cause the one or more processors to:
determine respective contracts between nodes of an operating system on one or more computing devices, the nodes comprising one or more provider nodes and one or more consumer nodes;
generate, based on the respective contracts, one or more provider node proxies and one or more consumer node proxies;
generate one or more first messages between the one or more provider nodes or the one or more provider node proxies and the one or more consumer node proxies or the one or more consumer nodes;
generate one or more second messages between the one or more consumer node proxies or the one or more consumer node proxies and the one or more provider nodes or the one or more provider node proxies; and
determine, based on at least one of the one or more first messages and the one or more second messages, a state of one or more contracts of the respective contracts.
